(19) United States
(12) Patent Application Publication
(10) Pub. No.: US 2025/0239601 A1
(43) Pub. Date: Jul. 24, 2025

(54) COMPOSITE PARTICLE, ELECTRODE MIXTURE, ELECTRODE LAYER, BATTERY, AND METHOD FOR PRODUCING ELECTRODE LAYER

(71) Applicant: TOYOTA JIDOSHA KABUSHIKI KAISHA, Toyota-shi (JP)

(72) Inventors: Kazushige NOMOTO, Sunto-gun (JP); Hideaki Nishimura, Sunto-gun (JP)

(73) Assignee: TOYOTA JIDOSHA KABUSHIKI KAISHA, Toyota-shi (JP)

(21) Appl. No.: 19/024,270

(22) Filed: Jan. 16, 2025

(30) Foreign Application Priority Data
Jan. 23, 2024 (JP) 2024-007973

(51) Int. Cl. H01M 4/38; H01M 4/02; H01M 4/04; H01M 4/134; H01M 4/1395; H01M 4/62; H01M 10/0525; H01M 10/0585

(52) U.S. Cl. CPC H01M 4/386; H01M 4/0404; H01M 4/0435; H01M 4/134; H01M 4/1395; H01M 4/623; H01M 10/0525; H01M 10/0585; H01M 2004/027

(57) ABSTRACT

A main object of the present disclosure is to provide a composite particle capable of suppressing a battery resistance. The present disclosure achieves the object by providing a composite particle including: a plurality of active material containing a Si element or a Sn element; and a binder, wherein, when a cross-section of the composite particle is observed, the composite particle includes a first portion containing the active material, and a second portion not containing the active material, and a rate of the second portion in the composite particle is 55% or less.

### TECHNICAL FIELD

The present disclosure relates to a composite particle, an electrode mixture, an electrode layer, a battery, and a method for producing an electrode layer.

### BACKGROUND ART

In recent years, the development of a battery has been actively carried out. For example, the development of a battery used for battery electric vehicles (BEV), plug-in hybrid electric vehicles (PHEV), or hybrid electric vehicles (HEV) has been advanced in the automobile industry. Also, the development of members and materials to be used for the battery has been advanced.

For example, Patent Literature 1 discloses an anode layer containing a composite particle including a plurality of particles including a Si element or a Sn element, and a binder, wherein a void rate is 15% or less.

### CITATION LIST

### Patent Literature

Patent Literature 1: Japanese Patent Application Laid-Open (JP-A) No. 2019-121557

### SUMMARY OF DISCLOSURE

### Technical Problem

The theoretical capacities of Si and Sn are large and it is advantageous to allow a battery to have high energy density. On the other hand, the volume change amount during charge and discharge is large, and there is a risk that the volume change amount (expansion/contraction amount) of the electrode layer using Si or Sn may be large. When the volume change amount of the electrode is large, there is a risk that the ion conduction path may be cut out to increase the battery resistance. In this point, as in Patent Literature 1, it has been considered to intend the absorption of the expansion of the composite particle by arranging a void in the anode layer, and to suppress the battery resistance by inhibiting the cut-out of the ion conduction path. Meanwhile, there is room for further improvement for suppressing the battery resistance.

The present disclosure has been made in view of the above circumstances, and a main object thereof is to provide a composite particle capable of suppressing a battery resistance.

### Solution to Problem

[1]

A composite particle comprising: a plurality of active material containing a Si element or a Sn element; and a binder, wherein
when a cross-section of the composite particle is observed,
the composite particle includes a first portion containing the active material, and a second portion not containing the active material, and a rate of the second portion in the composite particle is 55% or less.
[2]

The composite particle according to [1], wherein the rate is 30% or more.
[3]

The composite particle according to [1] or [2], wherein the active material contains the Si element, and includes a void inside.
[4]

The composite particle according to any one of [1] to [3], wherein the active material contains the Si element, and includes a silicon clathrate type crystal phase.
[5]

An electrode mixture comprising the composite particle according to any one of [1] to [4].
[6]

An electrode layer comprising a composite particle, wherein
the composite particle includes: a plurality of active material containing a Si element or a Sn element; and a binder; and
when a cross-sectional shape of the composite particle in the electrode layer is approximated to an oval,
an aspect ratio of the composite particle is 3.6 or less.
[7]

The electrode layer according to [6], wherein the aspect ratio is 3.0 or less.
[8]

The electrode layer according to [6] or [7], wherein the aspect ratio is 1.6 or more.
[9]

The electrode layer according to any one of [6] to [8], wherein the electrode layer contains a conductive aid and a solid electrolyte.
[10]

A battery comprising a cathode active material layer, an anode active material layer, and an electrolyte layer arranged between the cathode active material layer and the anode active material layer, wherein
the anode active material layer is the electrode layer according to any one of [6] to [9].
[11]

The battery according to [10], wherein the electrolyte layer is a solid electrolyte layer.
[12]

A method for producing an electrode layer, the method comprising:
a preparing step of preparing an electrode mixture containing the composite particle according to any one of [1] to [4];
a precursor layer forming step of forming a precursor layer using the electrode mixture; and
an electrode layer forming step of forming an electrode layer by applying a pressing pressure to the precursor layer, wherein
in the electrode layer forming step,
when a cross-sectional shape of the composite particle in the electrode layer is approximated to an oval,
the pressing pressure is applied so that an aspect ratio of the composite particle becomes 3.6 or less.
[13]

The method for producing an electrode layer according to [12], wherein
the pressing pressure is applied by roll-pressing in the electrode layer forming step; and
the pressing pressure is 30 kN/cm or more and 100 kN/cm or less.

### Advantageous Effects of Disclosure

The composite particle in the present disclosure exhibits an effect of suppressing the battery resistance when used in a battery.

### BRIEF DESCRIPTION OF DRAWINGS

FIGS. 1A and 1B are diagrams explaining the method for measuring the rate of the second portion in the present disclosure.

FIGS. 2A to 2C are diagrams explaining the crystal phases of the Si-based active material in the present disclosure.

FIGS. 3A to 3D are diagrams explaining the method for measuring the aspect ratio in the present disclosure.

FIG. 4 is a schematic cross-sectional view exemplifying the battery in the present disclosure.

FIG. 5 is a flow chart exemplifying the method for producing the electrode layer in the present disclosure.

FIGS. 6A and 6B are graphs showing the results of Examples and Comparative Examples.

### DESCRIPTION OF EMBODIMENTS

The composite particle, the electrode mixture, the electrode layer, the battery, and the method for producing of the electrode layer in the present disclosure will be hereinafter explained in details.

### A. Composite Particle

The composite particle in the present disclosure includes, a plurality of active material containing a Si element or a Sn element, and a binder. Also, when a cross-section of the composite particle is observed, the composite particle includes a first portion containing a Si-based active material or a Sn-based active material, and a second portion not containing the active material, and a rate of the second portion in the composite particle is 55% or less. Here, in the present specification, an active material containing a Si element may be referred to as a Si-based active material, and an active material containing a Sn element may be referred to as a Sn-based active material.

The composite particle in the present disclosure contains the specified active material and binder, and includes the specified second portion in the cross-sectional observation. For this reason, the second portion absorbs the expansion to suppress the volume change of the composite particle. As a result, when the composite particle is used for a battery, the battery resistance can be suppressed.

Also, in the composite particle in the present disclosure, since the rate of the second portion is 55% or less, it is possible to have the specified aspect ratio in the electrode layer. Although the details will be described later, it is presumed that the bending degree of the ion conduction path in the electrode layer can be decreased when the composite particle has the specified aspect ratio in the electrode layer. As a result, reaction unevenness in the thickness direction of the electrode layer can be suppressed, the volume change amount of the electrode layer can be suppressed, and the battery resistance can be suppressed.

The composite particle in the present disclosure includes, when a cross-section of the composite particle is observed, a first portion containing the active material, and a second portion not containing the active material. The second portion usually refers to a portion which is formed between adjacent active materials, and includes a void or a binder. Incidentally, when the Si-based active material includes a void inside as described later, the void portion inside the Si-based active material is included in the first portion.

The rate of the second proportion may be 50% or less, may be 45% or less, and may be 40% or less. Meanwhile, the rate of the second portion is, for example, 30% or more and may be 35% or more.

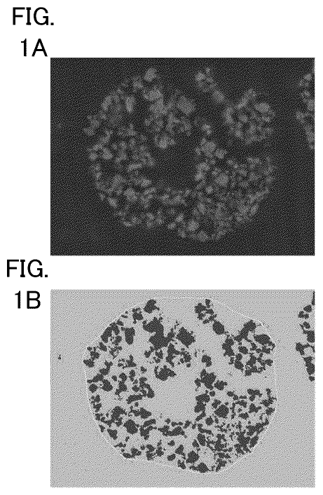

Here, the rate of the second proportion can be calculated by the following method for example. First, as shown in FIG. 1A, a cross-sectional image of the composite particle is obtained by a scanning electron microscope (SEM). The method for obtaining the cross-sectional image will be described in more details in Examples. Next, as shown in FIG. 1B, image analysis is performed to the cross-sectional image, and the first portion (dark portion in FIG. 1B) containing the Si-based active material or the Sn-based active material, and the second portion (light portion in FIG. 1B) not containing the active material, are binarized. Then, in the binarized image, the rate of the area of the second portion with respect to the total area of the first portion and the second portion is calculated by an image analyzing software. The rate of the second portion in the present disclosure is preferably an average value of 10 pieces or more of the samples (composite particles) measured. The number of the samples may be 20 pieces or more, may be 50 pieces or more, and may be 100 pieces or more.

The composite particle in the present disclosure includes, a plurality of active material containing a Si element or a Sn element, and a binder. Here, the composite particle can be taken as an aggregate in which a plurality of the active material (Si-based active material or Sn-based active material) are aggregated. Incidentally, the active material may be a primary particle, and may be a secondary particle which is aggregation of the primary particles.

An active material containing a Si element (Si-based active material) may be a simple substance of Si, may be an alloy containing Si as a main component (Si alloy), and may be a Si oxide. The proportion of the Si element in the Si alloy is, for example, 50 mol % or more and 95 mol % or less.

Also, the Si-based active material may include a void inside. Incidentally, the Si-based active material including void is called a porous Si. Presence of the void can be confirmed by a SEM (scanning electron microscope) observation. Also, the void rate is not particularly limited, but for example, it is 4% or more and may be 10% or more. Also, the void rate is, for example, 40% or less and may be 20% or less. The void rate can be obtained by, for example, in the following procedures. First, a cross-sectional image of the Si-based active material is obtained by SEM. From the obtained image, a silicon portion and the void portion are distinguished using an image analyzing software, and binarized. The areas of the silicon portion and the void portion are obtained, and the void rate (%) is calculated from the below equation:

$$Void rate ( \% ) = 100 * ( Area of void portion ) \text{} / ( ( Area of silicon portion ) + ( Area of void portion ) ) .$$

In the porous Si, a void amount of a void with a pore diameter of 50 nm or less is, for example, 0.05 cc/g or more and 0.30 cc/g or less. Also, the BET specific surface area of the porous Si is, for example, 20 m²/g or more and 200 m²/g or less.

Examples of the method for producing the porous Si may include a method in which an alloy of Li with Si (LiSi alloy) is produced and then Li is removed from the LiSi alloy. The LiSi alloy may be obtained by, for example, mixing Li and Si. Examples of the method for removing Li from the LiSi alloy may include a method in which the LiSi alloy is brought into reacting with Li extracting agent. Examples of the Li extracting agent may include alcohol such as methanol and acid such as acetic acid.

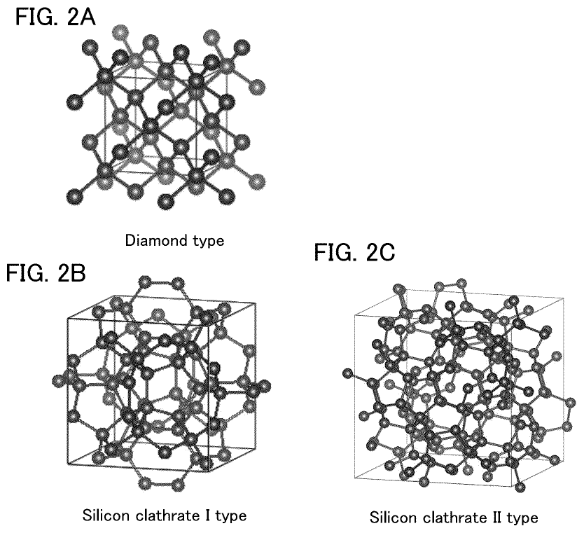

Here, FIGS. 2A to 2C are schematic perspective views explaining the crystal phases of Si. In general, Si includes a diamond type crystal phase as shown in FIG. 2A. In contrast, the Si-based active material in the present disclosure may include a silicon clathrate type crystal phases as shown in FIGS. 2B and 2C. In the diamond type crystal phase shown in FIG. 2A, a plurality of Si elements form a tetrahedron. The tetrahedron does not have a space inside to include metal ions such as Li ions. Meanwhile, in the silicon clathrate I type and II type crystal phases shown in FIGS. 2B and 2C, a backbone atom includes a basket type structure (cage), and metal ions such as Li ions can enter there, and thus the expansion and contraction of the composite particle can be further suppressed. As a result, the expansion and contraction of the electrode layer can be further suppressed. Incidentally, the Si-based active material including the silicon clathrate type crystal phase is referred to as a clathrate Si, and in particular, the Si-based active material including the void as well as the clathrate type crystal phase is referred to as a porous clathrate Si (pc-Si).

The Si-based active material may include a silicon clathrate I type crystal phase, and may include a silicon clathrate II type crystal phase. In particular, the Si-based active material preferably includes the silicon clathrate II type crystal phase as a main phase. “Main phase” means that the peak belonging to that crystal phase has the largest diffraction intensity among the peaks observed in an X-ray diffraction measurement. The proportion of the silicon clathrate II type crystal phase included in the Si-based active material is, for example, 80 weight % or more, may be 85 weight % or more, may be 90 weight % or more, and may be 95 weight % or more. Also, the proportion of the silicon clathrate II type crystal phase included in the Si-based active material may be 100 weight %, and may be less than 100 weight %. The proportion of the crystal phase can be obtained by using a RIR method (Reference Intensity Ratio method).

Examples of the method for producing the porous clathrate Si may include a method in which the porous Si and a Na source such as NaH are mixed and heated to produce a Na—Si alloy, and the Na amount in the Na—Si alloy is reduced by heating the Na—Si alloy to generate the silicon clathrate type crystal phase.

The active material containing a Sn element (Sn-based active material) may be a simple substance of Sn, may be an alloy containing Sn as a main component (Sn alloy), and may be a Sn oxide. The proportion of the Sn element in the Sn alloy is, for example, 50 mol % or more and 95 mol % or less.

The proportion of the Si-based active material or the Sn-based active material in the composite particle is, for example, 90 weight % or more and 99 weight % or less.

There are no particular limitations on the binder in the present disclosure. Examples of the binder may include a polyimide-based binder; a rubber-based binder such as an amine modified butadiene rubber (ABR), a butadiene rubber (BR), and a styrene butadiene rubber (SBR); a cellulose-based binder such as carboxy methyl cellulose (CMC); an acryl-based binder such as polyacrylic acid, polyacrylate, and polyacrylic ester; and a fluoride-based binder such as polyvinylidene fluoride (PVDF) and polytetra fluoroethylene (PTFE). The binder may be used in just one kind, and may be used by mixing a plural kinds.

The proportion of the binder in the composite particle is, for example, 0.5 weight % or more, and may be 10 weight % or less.

The average particle size (D₅₀) of the composite particle is, for example, 1 μm or more and 100 μm or less. The average particle size (D₅₀) refers to a volume accumulation particle size obtained by a measurement with a laser diffraction scattering particle distribution measurement method. Also, the average particle size (D₅₀) of the active material is, for example, 0.1 μm or more and 3 μm or less. The number of the active material included in the composite particle is, for example, 10 pieces or more and 150 pieces or less. The applications of the composite particle are not particularly limited, but it is preferable to be used for a battery.

### B. Electrode Mixture

The electrode mixture in the present disclosure contains the above described composite particle. Also, the electrode mixture may further contain at least one of a conductive aid, a binder, and an electrolyte, as required.

According to the present disclosure, the above described composite particle is included, and thus the battery resistance can be suppressed when used for a battery.

The proportion of the composite particle in the electrode mixture is not particularly limited, but for example, it is 50 weight % or more, may be 70 weight % or more, and may be 90 weight % or more. Meanwhile, the proportion of the composite particle is, for example, 99 weight % or less, and may be 95 weight % or less.

Examples of the conductive aid may include a carbon material. Examples of the carbon material may include a particulate carbon material such as acetylene black (AB) and Ketjen black (KB); and a fiber carbon material such as carbon fiber, carbon nanotube (CNT) and carbon nanofiber (CNF). The proportion of the conductive aid in the electrode mixture is, for example, 0.01 weight % or more and 10 weight % or less, and may be 0.1 weight % or more and 5 weight % or less.

Examples of the binder may include the binders described in “A. Composite particle”. The binder in the composite particle and the binder in the electrode mixture may be the same kind, and may be different kinds. The proportion of the binder in the electrode mixture is, for example, 0.5 weight % or more and 10 weight % or less, and may be 1 weight % or more and 5 weight % or less.

The electrode mixture preferably contains a solid electrolyte as an electrolyte. Examples of the solid electrolyte may include an inorganic solid electrolyte such as a sulfide solid electrolyte, an oxide solid electrolyte, and a halide solid electrolyte. The sulfide solid electrolyte preferably contains sulfur(S) as a main component of the anion element. The oxide solid electrolyte preferably contains oxygen (O) as a main component of the anion element. The halide solid electrolyte preferably contains halogen as a main component of the anion. Among these, a sulfide solid electrolyte is preferable.

It is preferable that the sulfide solid electrolyte contains a Li element, an M element (M is at least one kind of P, Sn, Al, Zn, In, Ge, Si, Sb, Ga and Bi), and a S element. Also, the sulfide solid electrolyte may contain a halogen element such as F, Cl, Br, and I. Also, in the sulfide solid electrolyte, a part of the S element may be substituted with an O element.

The sulfide solid electrolyte may be a glass-based (amorphous) sulfide solid electrolyte, may be a glass ceramic-based sulfide solid electrolyte, and may be a crystal-based sulfide solid electrolyte. Examples of the crystal phase included in the sulfide solid electrolyte may include a LGPS type crystal phase, a Thio-LISICON type crystal phase, and an argyrodite type crystal phase.

Examples of the sulfide solid electrolyte may include Li₂S—P₂S₅, Li₂S—P₂S₅—LiI, Li₂S—P₂S₅—GeS₂, Li₂S—P₂S₅—Li₂O, Li₂S—P₂S₅—Li₂O—LiI, Li₂S—P₂S₅—LiI—LiBr, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (provided that m, n is a positive number; Z is any one of Ge, Zn, and Ga), Li₂S—GeS₂, Li₂S—SiS₂—Li₃PO₄, and Li₂S—SiS₂-LiₓMO_{y} (provided that x, y is a positive number; M is any one of P, Si, Ge, B, Al, Ga, and In).

The proportion of the solid electrolyte in the electrode mixture is, for example, 30 weight % or more and 80 weight % or less, and may be 40 weight % or more and 70 weight % or less.

Also, the electrode mixture in the present disclosure may contain a dispersion medium such as an organic solvent. In other words, the electrode mixture may be a slurry. Meanwhile, the electrode mixture may be powder. Examples of the organic solvent may include conventionally known organic solvents in the field of the battery such as butyl butyrate.

### C. Electrode Layer

The electrode layer in the present disclosure is an electrode layer including a composite particle, wherein the composite particle includes: a plurality of active material containing a Si element or a Sn element; and a binder; and when a cross-sectional shape of the composite particle in the electrode layer is approximated to an oval, an aspect ratio of the composite particle is 3.6 or less. Incidentally, “cross-sectional shape of the composite particle in the electrode layer” means the cross-sectional shape of the composite particle that can be observed when the cross-section of the electrode layer is viewed in the thickness direction.

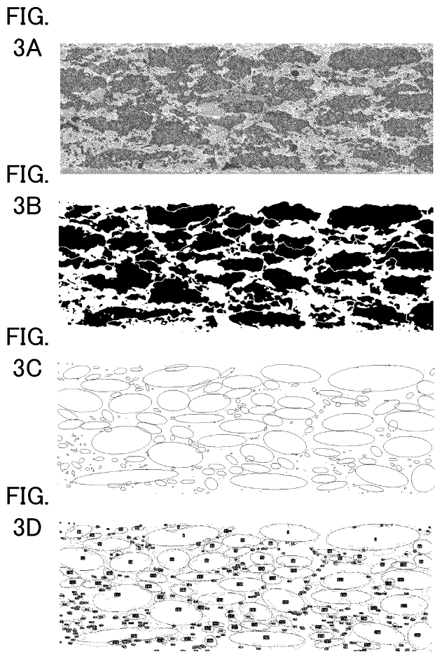

The aspect ratio in the present disclosure refers to a rate (b/a), which is the rate of a long diameter b with respect to a short diameter a of the composite particle obtained when the cross-sectional shape of the composite particle is approximated to an oval. Here, it is presumed that the electrode layer is produced by applying a pressing pressure as described later. In other words, it is presumed that the composite particle is included in the electrode layer in a state compressed in the thickness direction of the electrode layer. For this reason, the short diameter a of the composite particle can be taken as a length of the composite particle in the thickness direction of the electrode layer (up and down direction of the paper in FIGS. 3A to 3D described later). Also, the long diameter b of the composite particle can be taken as a length of the composite particle in a direction crossing the thickness direction of the electrode layer (left and right direction of the paper in FIGS. 3A to 3D described later).

According to the present disclosure, the composite particle of which specified aspect ratio is 3.6 or less is included, and thus the electrode layer allows the battery resistance to be suppressed.

Here, in general, the carrier ion moves inside the electrode layer by passing through an electrolyte part with good ion conductivity. In other words, the ion conduction path of the carrier ion bends to circumvent the composite particle. For this reason, when the aspect ratio is larger than 3.6, the distance circumventing the composite particle will be long, and the ion conduction path in the thickness direction will be long, and thus the ion conduction resistance will be increased. As a result, the battery resistance increases. In contrast, in the electrode layer in the present disclosure, since the aspect ratio is 3.6 or less, the bending of the ion conduction path in the thickness direction can be decreased, and thus the increase in the battery resistance due to the increase in the ion conduction resistance can be inhibited.

The aspect ratio may be 3.5 or less, may be 3.3 or less, may be 3.0 or less, and may be 2.8 or less. Meanwhile, the aspect ratio is, for example, 1.5 or more, may be 1.6 or more, and may be 1.8 or more, may be 2.0 or more, may be 2.3 or more, and may be 2.5 or more.

The short diameter a and the long diameter b of the composite particle are not particularly limited if the aspect ratio is satisfied. The short diameter a is, for example, 0.1 μm or more and 30 μm or less. Also, the long diameter b is, for example, 1.0 μm or more and 100 μm or less.

Here, the short diameter, the long diameter, and the aspect ratio can be calculated by the following method for example. First, as shown in FIG. 3A, a cross-sectional image of the electrode layer is obtained by a scanning electron microscope (SEM). Next, as shown in FIG. 3B, an image analysis is performed to the cross-sectional image, and binarized into the composite particle portion (black) and a portion other than the composite particle (white). Incidentally, the composite particle portion and the other portion can be distinguished by, for example, an elemental analysis such as SEM-EDX. Next, as shown in FIG. 3C, in the binarized image, the composite particle portion is approximated to an oval by an image analyzing software. Then, as shown in FIG. 3D, the short diameter, the long diameter and the area with respect to each composite particle approximated to the oval is measured, and 10 pieces of the composite particle from the one with the largest cross-sectional area are selected. The aspect ratios (long diameter/short diameter) of each of the selected composite particles are measured from the short diameters and the long diameters, and the average value of the aspect ratios measured is obtained as the aspect ratio in the present disclosure.

The number of the composite particle to be selected may be more than 10 pieces. The number of the composite particle to be selected may be 30 pieces or more, may be 50 pieces or more, and may be 100 pieces or more. Also, the observation field of the SEM image is preferably the field including the composite particles with the numbers described above or more. The observation field is, for example, 1000 μm² or more and 50000 μm² or less. Also, as the image analyzing software, for example, ImageJ Fiji can be used.

The composite particle is in the same contents as those described in “A. Composite particle”. Here, it is presumed that the electrode layer is produced by applying a pressing pressure as described later. Thus, in the electrode layer, it is presumed that the rate of the second portion of the composite particle decreases compared to before the pressing pressure is applied. Also when the composite particle contains the porous Si, similarly, it is presumed that the void amount of the void with the pore diameter of 50 nm or less decreases compared to before the pressing pressure is applied.

The electrode layer may be a cathode active material layer containing the composite particle as a cathode active material, and may be an anode active material layer containing the composite particle as an anode active material, but the latter is preferable. The reason therefor is to obtain a battery with high voltage. Also, the electrode layer may further contain at least one of a conductive aid, a binder, and an electrolyte, as required. The conductive aid, the binder and the electrolyte are in the same contents as those described in “B. Electrode mixture”.

The thickness of the electrode layer is not particularly limited, but for example, it is 0.1 μm or more and 1000 μm or less.

### D. Battery

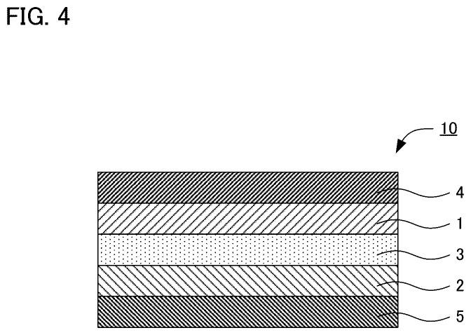

FIG. 4 is a schematic cross-sectional view exemplifying the battery in the present disclosure. Battery 10 shown in FIG. 4 includes cathode active material layer 1, anode active material layer 2, and electrolyte layer 3 arranged between the cathode active material layer 1 and the anode active material layer 2. Also, the anode active material layer 2 in the battery 10 is the above described electrode layer in the present disclosure.

### 1. Cathode Active Material Layer

The cathode active material layer contains at least a cathode active material, and contains at least one of a conductive aid, a binder, and an electrolyte, as required. The conductive aid, the binder and the electrolyte are in the same contents as those described in “B. Electrode mixture”.

The cathode active material is not particularly limited if it is an active material having higher reaction potential than that of the composite particle. Examples of the cathode active material may include an oxide active material. Examples of the oxide active material may include a rock salt bed type active material such as LiCoO₂, LiNi_{0.8}Co_{0.15}Mn_{0.05}O₂ and LiNi_{0.33}Co_{0.33}Mn_{0.33}O₂, a spinel type active material such as LiMn₂O₄ and Li₄Ti₅O₁₂, and an olivine type active material such as LifePO₄. Examples of the shape of the cathode active material may include a granular shape. The average particle size (D₅₀) of the cathode active material is, for example, 0.5 μm or more and 50 μm or less. The average particle size (D₅₀) is as described above.

The thickness of the cathode active material layer is not particularly limited, but for example, it is 0.1 μm or more and 1000 μm or less.

### 2. Anode Active Material Layer

The anode active material layer is the above described electrode layer. The electrode layer is in the same contents as those described in C. Electrode layer”.

### 3. Electrolyte Layer

The electrolyte layer contains an electrolyte. The electrolyte is preferably a solid electrolyte. The solid electrolyte is in the same contents as those described in “B. Electrode mixture”. Also, the electrolyte layer may contain a binder as required. The binder is in the same contents as those described in “B. Electrode mixture”. Incidentally, in the present disclosure, the electrolyte layer containing a solid electrolyte is called a solid electrolyte layer, and a battery including the solid electrolyte layer is called an all solid state battery.

The thickness of the electrolyte layer is not particularly limited, but for example, it is 0.1 μm or more and 1000 μm or less.

### 4. Other Constitutions

As shown in FIG. 4, battery 10 in the present disclosure usually includes cathode current collector 4 for collecting electrons of the cathode active material layer 1, and anode current collector 5 for collecting electrons of the anode active material layer 2. Examples of the material for the cathode current collector may include SUS, aluminum, nickel, iron, titanium, and carbon. Examples of the material for the anode current collector may include SUS, copper, nickel, and carbon.

Also, the battery in the present disclosure may include an outer package for storing the above described members. Examples of the outer package may include a laminate type outer package and a case type outer package. Also, the battery in the present disclosure may include a restraining jig that applies a restraining pressure of a thickness direction to the above described members. As the restraining jig, known jigs may be used. The restraining pressure is, for example, 0.1 MPa or more and 50 MPa or less, and may be 1 MPa or more and 20 MPa or less.

### 5. Battery

The battery in the present disclosure is typically a lithium ion secondary battery. Also, the battery in the present disclosure is preferably an all solid state battery including a solid electrolyte layer as an electrolyte layer. Examples of the applications of the battery may include a power source for vehicles such as hybrid electric vehicles (HEV), plug-in hybrid electric vehicles (PHEV), battery electric vehicles (BEV), gasoline-fueled automobiles and diesel powered automobiles. Also, the battery in the present disclosure may be used as a power source for moving bodies other than vehicles (such as rail road transportation, vessel and airplane), and may be used as a power source for electronic products such as information processing equipment.

### E. Method for Producing Electrode Layer

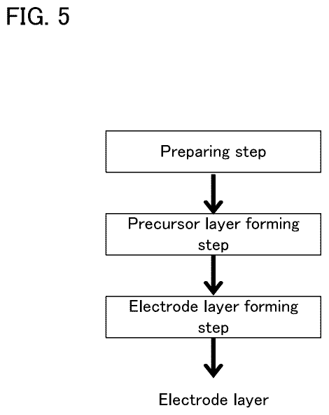

FIG. 5 is a flow-chart exemplifying the method for producing the electrode layer in the present disclosure. As shown in FIG. 5, in the method for producing the electrode layer in the present disclosure, first, an electrode mixture containing the above described composite particle is prepared (preparing step). Next, a precursor layer is formed using the electrode mixture (precursor layer forming step). Then, an electrode layer is formed by applying a pressing pressure to the precursor layer (electrode layer forming step). Also, in the electrode layer forming step, when a cross-sectional shape of the composite particle in the electrode layer is approximated to an oval, the pressing pressure is applied so that an aspect ratio of the composite particle becomes 3.6 or less.

According to the present disclosure, the electrode mixture containing the above described composite particle is used to form the precursor layer, and the pressing pressure is applied to the precursor layer, so as to form the electrode layer containing the composite particle with the specified aspect ratio. As a result, the electrode layer capable of suppressing the battery resistance when used in a battery can be produced.

### 1. Preparing Step

The preparing step is a step of preparing an electrode mixture containing the above described composite particle. The composite particle is in the same contents as those described in “A. Composite particle”. Also, the electrode mixture is in the same contents as those described in “B. Electrode mixture”.

### 2. Precursor Layer Forming Step

The precursor layer forming step is a step of forming a precursor layer using the electrode mixture.

In the precursor layer forming step, there are no particular limitations on the method for forming the precursor layer as long as a precursor layer in a layer shape can be formed from the electrode mixture. Examples of the method for forming the precursor layer may include a coating method using an electrode mixture that is a slurry. Examples of the coating method may include a method in which the electrode mixture is applied on a substrate such as a metal plate and dried. The thickness of the precursor layer is not particularly limited as long as the electrode layer with the desired thickness can be obtained, and may be appropriately adjusted.

### 3. Electrode Layer Forming Step

The electrode layer forming step is a step of forming an electrode layer by applying a pressing pressure to the precursor layer. Also, in the electrode layer forming step, when a cross-sectional shape of the composite particle in the electrode layer is approximated to an oval, the pressing pressure is applied so that an aspect ratio of the composite particle becomes 3.6 or less.

There are no particular limitations on the method for applying a pressing pressure (pressing method), and examples thereof may include roll-pressing and flat plate pressing. A pressing pressure (linear pressure) in the roll-pressing and a pressing pressure (surface pressure) in the flat plate pressing are not particularly limited as long as the aspect ratio can be obtained. The linear pressure in the roll-pressing is, for example, 30 kN/cm or more, may be 40 kN/cm or more, and may be 50 kN/cm or more. Meanwhile, the linear pressure is, for example, 100 kN/cm or less, may be 80 kN/cm or less, and may be 60 kN/cm or less. Also, the surface pressure in the flat plate pressing is, for example, 800 MPa or more and 3000 MPa or less. Also, pressing may be performed while heating the precursor layer. The heating temperature is, for example, 80° C. or more and 200° C. or less.

### 4. Electrode Layer

The electrode layer to be obtained through each of the above described steps is not particularly limited, but is preferably the electrode layer described in “C. Electrode layer”.

Incidentally, the present disclosure is not limited to the embodiments. The embodiments are exemplification, and any other variations are intended to be included in the technical scope of the present disclosure if they have substantially the same constitution as the technical idea described in the claims of the present disclosure and have similar operation and effect thereto.

### EXAMPLES

### Example 1

### <Production of Cathode>

A binder (PVDF), a conductive aid, a sulfide solid electrolyte, and a cathode active material (NCM: LiNi_{0.8}Co_{0.15}Mn_{0.05}O₂) were added to an organic solvent. After adding, the product was kneaded using an ultrasonic homogenizer to obtain an electrode mixture slurry. The obtained electrode mixture slurry was applied on a cathode current collector (Al foil) and dried. Thereby, a cathode including a cathode current collector and a cathode active material layer was obtained.

### <Production of Anode>

A Si-based active material (pc-Si: average particle size (D₅₀) 0.5 μm) was projected into a binder solution containing an organic solvent and a binder (PVDF), and mixed to prepare a slurry. A composite particle containing a Si-based active material and a binder was produced by a spraying drying method using this slurry.

Regarding the produced composite particle, the rate of the second portion was measured in the following manner. The results are shown in Table 1. First, the composite particle and an epoxy resin were mixed and cured to obtain a solid product. Next, a cross-section takeout processing by an ion milling method was performed to the solid product. The processed cross-section was observed by SEM to obtain the cross-sectional image of the composite particle. Regarding the obtained cross-sectional image, the portion containing the Si-based active material (first portion) and the portion not containing the Si-based active material (second portion) were binarized, and the rate of the second portion in each of the composite particle was calculated. Then, the average value of the rates of the second portions of 10 pieces of the composite particles was obtained. Incidentally, in the cross-section of the composite particle observed, as shown in FIGS. 1A and 1B, it was observed as a sea island structure wherein the second portion was sea and the first portion was island.

The composite particle, a binder (PVDF), a conductive aid (VGCF) and a sulfide solid electrolyte (Li₂S—P₂S₅-based sulfide solid electrolyte) were added to an organic solvent, and kneaded using an ultrasonic homogenizer. Thereby, an anode slurry was produced. The anode slurry was applied on an anode current collector (Cu foil) and dried. Thereby, an anode including an anode current collector and an anode active material layer was obtained.

### <Production of Evaluation Battery>

A binder (PVDF), and a sulfide solid electrolyte (Li₂S—P₂S₅-based sulfide solid electrolyte) were added to an organic solvent, and kneaded using an ultrasonic homogenizer. Thereby, a mixture slurry was obtained. The mixture slurry was applied on a substrate (Al foil) and dried. Thereby, a transfer member including the substrate and the solid electrolyte layer was obtained.

The produced cathode, anode, and transfer member were respectively formed into a strip shape. Next, the cathode and the transfer member were overlapped so that the cathode active material layer and the solid electrolyte layer faced to each other, and roll-pressed at 165° C. and a pressure of 50 kN/cm. After that, the substrate was peeled off, and thereby a cathode side member was obtained. Also, the anode and the transfer member were overlapped so that the anode active material layer and the solid electrolyte layer faced to each other, and roll-pressed at 25° C. and a pressure of 50 kN/cm. After that, the substrate was peeled off, and thereby an anode side member was obtained. Next, the anode side member was punched out into @13.00 mm, and the cathode side member was punched out into @11.28 mm. Powder sulfide solid electrolyte was arranged on the solid electrolyte layer of the punched out anode side member, and uniaxially pressed. Next, the anode side member and the cathode side member were overlapped so that the solid electrolyte layers faced to each other, and tabs for taking out currents were installed to the cathode and the anode. Then, the product was sealed in an aluminum laminate using a vacuum lami-sealer, and restrained at a pressure of 5 MPa. Thereby, an evaluation battery (all solid state battery) was produced.

### Examples 2 to 7 and Comparative Examples 1 to 5

A composite particle with the rate of the second portion as shown in Table 1 was respectively produced by changing the solid content rate of the slurry in the production of the composite particle. An evaluation battery was respectively produced in the same manner as in Example 1 except that these composite particles were respectively used to produce the anode.

### [Evaluation]

### <Measurement of Aspect Ratio>

A SEM observation was performed to the produced evaluation battery, and a cross-sectional SEM image of the anode active material layer was obtained. The aspect ratio of the composite particle in the anode active material layer was respectively calculated from the cross-sectional SEM images of the anode active material layers by the above described method. The results are shown in Table 1.

### <Measurement of Battery Resistance>

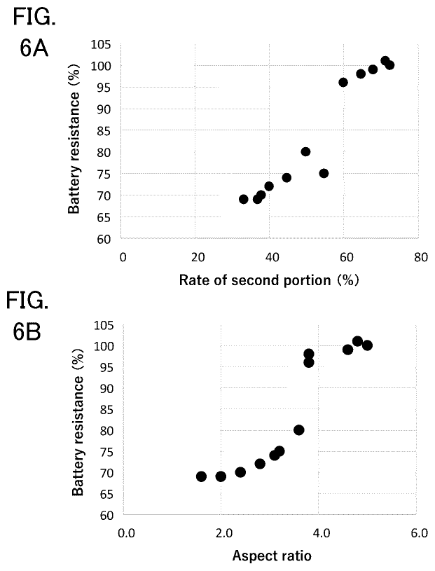

Each of the produced evaluation batteries was adjusted to the voltage of 3.7 V. Then, the batteries were discharged at 5 C, and the resistance value was respectively calculated based on the voltage drop amount after 5 seconds from the discharge. The resistance value of Comparative Example 1 was regarded as 100%, and the evaluation was relatively performed. The results are shown in Table 1. Also, the relation between the battery resistance and the rate of the second portion is shown in FIG. 6A, and the relation between the battery resistance and the aspect ratio is shown in FIG. 6B.

TABLE 1

| | | | Short | Long | |
|---|---|---|---|---|---|
| | Rate of second | Aspect | diameter a | diameter b | Battery |
| | portion (%) | ratio | (μm) | (μm) | resistance(%) |
| Comp. Ex. 1 | 72.4 | 5.0 | 2.4 | 12.1 | 100 |
| Comp. Ex. 2 | 71.2 | 4.8 | 2.5 | 12.0 | 101 |
| Comp. Ex. 3 | 67.9 | 4.6 | 2.4 | 11.1 | 99 |
| Comp. Ex. 4 | 64.6 | 3.8 | 2.6 | 9.9 | 98 |
| Comp. Ex. 5 | 59.9 | 3.8 | 2.8 | 10.6 | 96 |
| Example 1 | 54.7 | 3.2 | 2.8 | 9.0 | 75 |
| Example 2 | 49.8 | 3.6 | 2.8 | 10.1 | 80 |
| Example 3 | 44.7 | 3.1 | 2.7 | 8.5 | 74 |
| Example 4 | 39.9 | 2.8 | 3.0 | 8.4 | 72 |
| Example 5 | 37.8 | 2.4 | 2.9 | 7.0 | 70 |
| Example 6 | 36.8 | 2.0 | 3.4 | 6.8 | 69 |
| Example 7 | 33.1 | 1.6 | 3.7 | 5.9 | 69 |

As shown in Table 1 and FIGS. 6A and 6B, it was confirmed that the aspect ratio of the composite particle was 3.6 or less in the electrode layers produced using the composite particles of which rate of the second portion was 55% or less. Also, it was confirmed that the battery resistance was remarkably suppressed in the batteries using these electrode layers.

### REFERENCE SINGS LIST

1 cathode active material layer
2 anode active material layer
3 electrolyte layer
4 cathode current collector
5 anode current collector
10 battery

What is claimed is:

1. A composite particle comprising: a plurality of active material containing a Si element or a Sn element; and a binder, wherein
when a cross-section of the composite particle is observed, the composite particle includes a first portion containing the active material, and a second portion not containing the active material, and a rate of the second portion in the composite particle is 55% or less.

2. The composite particle according to claim 1, wherein the rate is 30% or more.

3. The composite particle according to claim 1, wherein the active material contains the Si element, and includes a void inside.

4. The composite particle according to claim 1, wherein the active material contains the Si element, and includes a silicon clathrate type crystal phase.

5. An electrode mixture comprising the composite particle according to claim 1.

6. An electrode layer comprising a composite particle, wherein
the composite particle includes: a plurality of active material containing a Si element or a Sn element; and a binder; and
when a cross-sectional shape of the composite particle in the electrode layer is approximated to an oval,
an aspect ratio of the composite particle is 3.6 or less.

7. The electrode layer according to claim 6, wherein the aspect ratio is 3.0 or less.

8. The electrode layer according to claim 6, wherein the aspect ratio is 1.6 or more.

9. The electrode layer according to claim 6, wherein the electrode layer contains a conductive aid and a solid electrolyte.

10. A battery comprising a cathode active material layer, an anode active material layer, and an electrolyte layer arranged between the cathode active material layer and the anode active material layer, wherein
the anode active material layer is the electrode layer according to claim 6.

11. The battery according to claim 10, wherein the electrolyte layer is a solid electrolyte layer.

12. A method for producing an electrode layer, the method comprising:
a preparing step of preparing an electrode mixture containing the composite particle according to claim 1;
a precursor layer forming step of forming a precursor layer using the electrode mixture; and
an electrode layer forming step of forming an electrode layer by applying a pressing pressure to the precursor layer, wherein
in the electrode layer forming step,
when a cross-sectional shape of the composite particle in the electrode layer is approximated to an oval,
the pressing pressure is applied so that an aspect ratio of the composite particle becomes 3.6 or less.

13. The method for producing an electrode layer according to claim 12, wherein
the pressing pressure is applied by roll-pressing in the electrode layer forming step; and
the pressing pressure is 30 kN/cm or more and 100 kN/cm or less.
